(19) United States
(12) Patent Application Publication
(10) Pub. No.: US 2009/0159772 A1
(43) Pub. Date: Jun. 25, 2009

(54) Automobile window insert and accompanying window tool for hanging automobile accessories from an automobile window, together with attached automobile accessories

(76) Inventor: Angela Gale Noble, Ravenswood, WV (US)

Correspondence Address: Angela Gale Noble, Rt. 1, Box 37-A, Ravenswood, WV, 26164, US

(21) Appl. No.: 12/316,273

(22) Filed: Dec. 11, 2008

Related U.S. Application Data
(60) Provisional application No. 61/007,198, filed on Dec. 11, 2007.

(51) Int. Cl. F16M 13/00

(52) U.S. Cl. 248/317

(57) ABSTRACT

A unique automobile window insert and accompanying window tool for hanging automobile accessories from an automobile window, allowing for an incredibly secure and convenient attachment of automobile accessories to an automobile window. This invention allows automobile accessories to be within easy reach and stay in place even if accidently bumped or when traveling at high speeds or over uneven terrain. In addition, this invention includes any and all automobile accessories whatsoever, to be utilized by either the driver or passenger of an automobile, that may be attached to an automobile window by using the automobile window insert and/or accompanying window tool. These automobile accessories include, but are not limited to, all manner of cupholders, cellphone holders, iPod/MP3/satellite radio holders, CD holders, sunglasses holders, garbage holders, tissue holders, accessory/food trays/holders, and any and all types of holders, trays, containers, vessels or receptacles whatsoever. The automobile window insert and accompanying window tool, together with the attached automobile accessories, collapse into a convenient and easily carried and stored configuration when not in use.

### CROSS-REFERENCE TO RELATED APPLICATIONS

This application claims priority of U.S. Provisional Patent Application No. 61/007,198 filed Dec. 11, 2007, entitled “Automobile Window Insert and Accompanying Window Tool for Hanging Automobile Accessories from an Automobile Window, Together with Attached Automobile Accessories.”

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### FIELD OF THE INVENTION

This invention relates, generally, to a unique automobile window insert and accompanying window tool for hanging automobile accessories from an automobile window, allowing for an incredibly secure and convenient attachment of automobile accessories to an automobile window. More specifically, this invention allows automobile accessories to be within easy reach and stay in place even if accidently bumped or when traveling at high speeds or over uneven terrain. In addition, it relates to any and all items whatsoever, to be utilized by either the driver or passenger of an automobile, that may be attached to an automobile window by using the automobile window insert and/or accompanying window tool, including, but not limited to, all manner of cupholders, cellphone holders, iPod/MP3/satellite radio holders, CD holders, sunglasses holders, garbage holders, tissue holders, accessory/food trays/holders, and any and all types of holders, trays, containers, vessels or receptacles whatsoever. The automobile window insert and accompanying window tool, together with the attached automobile accessories, collapse into a convenient and easily carried and stored configuration when not in use.

### BACKGROUND OF THE INVENTION

Due to the fast paced life style of the world we live in, it is common practice for millions of people each day to spend untold hours in their cars. Traveling to and from work, running errands, grabbing a bite to eat on the go, picking up the kids and shuffling them back and forth to school and extracurricular activities, and taking long trips, all add up to hours upon hours of time spent in our automobiles. Since we spend so much time in our automobiles, we find that we need to bring along items to make us more comfortable, or provide a measure of safety, such as our cellphones, ipods, MP3 players, satellite radios, sunglasses, sunglasses holders, food and drink items, notepads, pens, maps, accessories chargers, mail, etc. It then becomes necessary to find a place to put everything we need and to keep our cars organized. Unfortunately, it can be difficult, within the cramped confines of an automobile, to find a convenient and safe place for all of those things that we need. Cellphones and iPods can slide off our laps into the floor possibly creating a driving hazard, sunglasses routinely get sat on, drink cups fall over and cause a distraction from driving the car, food can make a mess whether being consumed by the driver or passenger, notepads and pens are hard to keep track of, and the list goes on and on.

2. Discussion of the Prior Art

Prior to now, there has not been a convenient, simple and removable means by which to attach a variety of automobile accessories to the interior of an automobile. The invention herein provides an incredibly secure and convenient means to attach a multitude of varied automobile accessories to an automobile window, thus allowing all of those items drivers and passengers bring along in an automobile to make them more comfortable or provide a measure of safety, to be within easy reach and stay in place even if accidently bumped or when traveling at high speeds or over uneven terrain. Previous attempts have been made to provide for the attachment of various automobile accessories to the interior of an automobile. A search of the U.S. Patent and Trademark Office files revealed the following prior art patents:

U.S. Pat. No. 5,971,242, issued to Schuerman on Oct. 26, 1999, discloses a Vehicle Accessory Holder adapted to contain a variety of different items frequently used by the driver or passenger, such as cellular telephones, sunglasses and the like. Unlike the present invention, the Vehicle Accessory Holder requires attachment by use of a power plug or recharge plug which may hinder storage of certain items and limit the size of such items and does not provide a means for attaching a multitude of varied automobile accessories.

U.S. Pat. No. 5,690,307, issued to Joyce on Nov. 25, 1997, discloses a Vehicle Accessory Holder with a Gooseneck Shaft. Unlike the present invention, the Vehicle Accessory Holder is not easily removed and does not provide a means for attaching a multitude of varied automobile accessories.

U.S. Pat. No. 6,098,860, issued to Phillips on Aug. 8, 2000, discloses a Strap to Your Dash Cupholder. Unlike the present invention, the Strap to Your Dash Cupholder is not easily installed and removed for storage and does not provide a means for attaching a multitude of varied automobile accessories.

U.S. Pat. No. 6,189,851 B1, issued to Ozark, et al., on Feb. 20, 2001, discloses an Apparatus for Holding Beverage Containers and Other Articles. Unlike the present invention, the Apparatus for Holding Beverage Containers and Other Articles is cumbersome, not easily stored and does not provide a means for attaching a multitude of varied automobile accessories.

U.S. Pat. No. 7,344,177, issued to Glenn, on Mar. 18, 2008, discloses a Combined vehicle sun visor extender and CD holder. Unlike the present invention, the Combined vehicle sun visor extender and CD holder does not provide a means for attaching a multitude of varied automobile accessories.

U.S. Pat. No. 5,195,668, issued to Kunes, et al., on Mar. 23, 1993, discloses an Article Holder attached to a vehicle sun visor for holding sunglasses, eyeglasses, pens, pencils and mirrors. Unlike the present invention, the Article Holder does not provide a means for attaching a multitude of varied automobile accessories and will not accommodate a sunglasses case.

U.S. Pat. No. 4,576,320, issued to Mead, on Mar. 18, 1986, discloses an Eyeglass Holder for Operative Association with the Rear View Mirror on a Vehicle. Unlike the present invention, it does not provide a means for attaching a multitude of varied automobile accessories.

U.S. Pat. No. D545,214 S, issued to Carter, on Jun. 26, 2007, discloses a Disposable Automobile Garbage Bag. Unlike the present invention, it is necessary to continue to purchase disposable bags and does not provide a means for attaching a multitude of varied automobile accessories.

U.S. Pat. No. 6,474,610 B1, issued to Hsieh, on Nov. 5, 2002, discloses a Vehicle Tissue Box Placement Assembly. Unlike the present invention, it does not provide a means for attaching a multitude of varied automobile accessories.

While there are numerous inventions for automobile accessories in the prior art, none attach to an automobile window in a manner equivalent to the present invention, and none provide a means for attaching a multitude of varied automobile accessories.

### BRIEF SUMMARY OF THE INVENTION

In view of the foregoing disadvantages inherent in the prior art set forth herein, the automobile window insert and/or accompanying window tool herein, in their various shapes, sizes and modifications, provide an improved means for hanging within an automobile any and all items whatsoever to be utilized by either the driver or passenger of an automobile, including, but not limited to, all manner of cupholders, cellphone holders, iPod/MP3/satellite radio holders, CD holders, sunglasses holders, garbage holders, tissue holders, accessory/food trays/holders, and any and all types of holders, trays, containers, vessels or receptacles whatsoever; thus allowing for an incredibly secure and convenient attachment of said automobile accessories to the automobile window, allowing them to be within easy reach of a driver or passenger and stay in place even if accidently bumped or when traveling at high speeds or over uneven terrain.

The automobile window insert and/or accompanying window tool are useable by the driver and passengers of an automobile by using the window tool to pull back a portion of the rubber located at the bottom of the window and sliding a portion of the automobile window insert between the automobile window and its rubber surround and into that portion of the automobile into which the window disappears, thus allowing the automobile accessories to hang down from the window and rest on the door of the automobile or the body of the automobile, if there is no door below the window, whichever the case may be, to allow for convenience in utilizing and storing various cups, cellphones, ipods, MP3 players, satellite radios, CD's, sunglasses, sunglasses holders, food and drinks, garbage, tissues, accessories, notepads, pens, maps, accessories chargers, mail, and any and all items the user may desire.

The automobile window insert and automobile accessories herein are made from fabric, hard plastic, vinyl (optional), and hook and loop fasteners using conventional sewing methods; and the accompanying window tool is made from hard plastic; notwithstanding the above materials, it is specifically stated that the aforementioned automobile window insert, window tool and automobile accessories may be made or formed from any number of materials, including, but not limited to, one solid piece or multiple pieces of plastic, metal, fabric, or any and all materials whatsoever; and that the use of different materials to make the aforementioned, whether or not the items are made using conventional sewing methods, heat sealing, or any other method, and whether or not a window tool is necessary or required for their use, shall be considered as coming within the spirit of the invention and are desired to be protected.

The automobile window insert of this disclosure consists, generally, of: a piece of fabric of varying sizes, depending upon the automobile accessory to be attached to it, said fabric being cut on a fold and being divided into an upper section beginning along the fold in the fabric having a seam stitched up both the right and left sides to form a type of pocket into which a corresponding piece of hard plastic the size of said pocket is inserted along the fold from one side to the other and having a stitch below said corresponding piece of hard plastic from one side to the other to fully enclose said hard plastic, which upper section is used by sliding it between the automobile window and its rubber surround and inserting this entire upper section into that portion of the automobile into which the window disappears by means of the window tool described herein; a middle section being that portion of fabric extending downward from the upper section and serving the purpose of filling the gap between the upper section and the lower section described below, thus allowing the automobile accessory to hang properly below the window, and also, in some instances, containing a pocket for the storage of the window tool, said pocket being closed by hook and loop fasteners, and also in some instances being the location where the automobile window insert is stitched to the automobile accessory when a lower section is not needed; a lower section (optional) being that portion of the above fabric extending downward from the middle section and being the location where the automobile window insert is attached to the various automobile accessories.

The window tool of this disclosure is made from hard plastic of varying sizes depending upon the automobile accessory it accompanies, and having rounded and thinned out corners to allow for ease in pulling back a small portion of the automobile window's rubber surround allowing the upper portion of the automobile window insert to slide into place into that portion of the automobile into which the window disappears.

The automobile accessories are attached to the automobile window insert and consist generally of the following: fabric, vinyl (optional) of varying shapes and sizes, depending upon the automobile accessory being referred to, said fabric and vinyl (optional) being stitched to form a type of pocket or tray to be used as a cupholder, cellphone holder, iPod/MP3/satellite radio holder, CD holder, sunglasses holder, garbage holder, tissue holder, accessory/food tray/holder, and any and all types of holders, trays, containers, vessels or receptacles whatsoever, and the omission of a further particular description or drawing of any of said automobile accessories referred to herein shall not preclude their protection by virtue of this Nonprovisional Patent Application, said automobile accessories being more particularly described as follows:

1. The cupholder herein (which may be used to hold cups or any number of items desired by the user) being made of fabric and vinyl and consisting of a bottom section cut in circles of varying diameters depending upon the size of cupholder desired and being where the bottom of the cup will rest; said bottom section being attached to a top section, including a band around the top (optional), of varying sizes depending upon the size of the cupholder creating a type of circular pocket and being where the body of the cup will be held; and an automobile window insert being attached to the upper portion of the cupholder thus allowing it to hang from the automobile window.

2. The cellphone holder and iPod/MP3/satellite radio holder herein (which may be used to hold any number of items by the user) being made from fabric of varying shapes and sizes depending upon the size of the holder desired, including a band around the top (optional), said fabric being folded in half horizontally and being stitched across the bottom and down both sides in such a way as to form an accordion type opening on either side of the top, thus creating a type of flat, expandable pocket; and an automobile window insert being attached to the top of the holder thus allowing it to hang from the automobile window.

3. The CD holder and sunglasses holder herein (which may be used to hold any number of items by the user) being made from fabric of varying shapes and sizes depending upon the size of the holder desired, including a band around the top (optional), said fabric being folded in half horizontally and being stitched down one side and across the bottom in such a way as to create a type of flat pocket; and an automobile window insert being attached to the top of the holder thus allowing it to hang from the automobile window.

4. The garbage holder herein (which may be used to hold garbage or any number of items desired by the user) being made of fabric and vinyl and consisting of a bottom section cut in circles of varying diameters depending upon the size of holder desired and being the bottom of the garbage holder; said bottom section being attached to a top section, including a band around the top (optional), of varying sizes depending upon the size of the holder creating a type of circular pocket and being where the garbage will be held; and an automobile window insert being attached to the top section of the garbage holder thus allowing it to hang from the automobile window.

5. The tissue holder herein (which may be used to hold tissues or any number of items desired by the user) being made of fabric and consisting of a bottom section cut in a square of varying sizes depending upon the size of holder desired and being the bottom of the holder where the bottom of the box of tissues will rest; said bottom section being attached to a top section, including a band around the top (optional), of varying sizes depending upon the size of the holder, stitched in such a way to create four sides thus making a type of square pocket and being where the body of the tissue box will be held; and an automobile window insert being attached to the top section of the tissue holder thus allowing it to hang from the automobile window.

6. The accessory/food tray/holder herein (which may be used to hold any number of items desired by the user) being made of fabric and vinyl (optional), and hard plastic and consisting of the tray bottom; a tray lip, which together with the below referenced tray back, provides a continuous barrier that prevents items from sliding off the tray bottom; a tray back; and an automobile window insert being attached to the tray back thus allowing it to hang from the automobile window.

Accordingly, it is an object of the present invention, in their various shapes, sizes and modifications, to provide an improved means for hanging within an automobile any and all items whatsoever to be utilized by either the driver or passenger of an automobile, including, but not limited to, all manner of cupholders, cellphone holders, iPod/MP3/satellite radio holders, CD holders, sunglasses holders, garbage holders, tissue holders, accessory/food trays/holders, and any and all types of holders, trays, containers, vessels or receptacles whatsoever.

It is a further object of the present invention to provide an improved cupholder having a unique automobile window insert and/or accompanying window tool by which it may be attached to an automobile window.

It is a further object of the present invention to provide an improved cellphone holder having a unique automobile window insert and/or accompanying window tool by which it may be attached to an automobile window.

It is a further object of the present invention to provide an improved iPod/MP3/satellite radio holder having a unique automobile window insert and/or accompanying window tool by which it may be attached to an automobile window.

It is a further object of the present invention to provide an improved CD holder having a unique automobile window insert and/or accompanying window tool by which it may be attached to an automobile window.

It is a further object of the present invention to provide an improved sunglasses holder having a unique automobile window insert and/or accompanying window tool by which it may be attached to an automobile window.

It is a further object of the present invention to provide an improved garbage holder having a unique automobile window insert and/or accompanying window tool by which it may be attached to an automobile window.

It is a further object of the present invention to provide an improved tissue holder having a unique automobile window insert and/or accompanying window tool by which it may be attached to an automobile window.

It is a further object of the present invention to provide an improved accessory/food tray/holder having a unique automobile window insert and/or accompanying window tool by which it may be attached to an automobile window.

These, together with other objects of the invention, along with the various features of novelty which characterize the invention, will become more apparent hereinafter. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed descriptions thereof. Such descriptions make reference to the annexed drawings wherein:

FIG. 1 is an overhead view of a small sized automobile window insert prior to being attached to an automobile accessory, the top section being the section that inserts between the automobile window and its rubber surround and into that portion of the automobile into which the window disappears, by means of the accompanying window tool shown beside of the storage pocket located in the middle section of the automobile window insert.

FIG. 2 is an overhead view of a small sized automobile window insert and its accompanying window tool, prior to being attached to an automobile accessory, the hatched top section depicting the piece of hard plastic sewn inside, and the hatched portion of the middle section depicting the accompanying window tool in its storage pocket.

FIG. 3 is a depiction of the small sized window tool in use pulling back the window rubber surround in preparation for insertion of the automobile window insert.

FIG. 4 is a depiction of a large sized window tool in use pulling back the window rubber surround in preparation for insertion of the automobile window insert.

FIG. 5 is a depiction of the cupholder/garbage holder from a front view with a small sized automobile window insert attached and showing the window tool beside of the storage pocket located in the middle section of the automobile window insert.

FIG. 6 is a depiction of the cupholder/garbage holder from a back view showing the upper, middle and lower sections of its small sized automobile window insert, with the lower section being attached to the cupholder/garbage holder.

FIG. 7 is a depiction of a small sized automobile window insert attached to the cupholder in place between the automobile window glass and its rubber surround.

FIG. 8 is a side view of a small sized automobile window insert folded back with its upper, middle and lower sections depicted, and with its lower section being attached to the CD/sunglasses holder.

FIG. 9 is a side view of a small sized automobile window insert folded back with its upper, middle and lower sections depicted, and with its lower section being attached to the cellphone/iPod/MP3/satellite radio holder.

FIG. 10 is a depiction of a side view of a cellphone holder and sunglasses holder in use by the driver of an automobile with the automobile window inserts in place and a small sized window tool being placed in its storage pocket in the middle section of the automobile window insert located on the cellphone holder.

FIG. 11 is a depiction of a small sized automobile window insert attached to a tissue holder.

FIG. 12 is a depiction of a large sized automobile window insert, consisting of a top and middle section only, attached to an accessory/food tray/holder.

FIG. 13 is a depiction of a window tool in use allowing for the insertion of the large sized automobile window insert attached to an accessory/food tray/holder between the window glass and the window rubber surround on the automobile driver's side door.

### DETAILED DESCRIPTION OF THE INVENTION

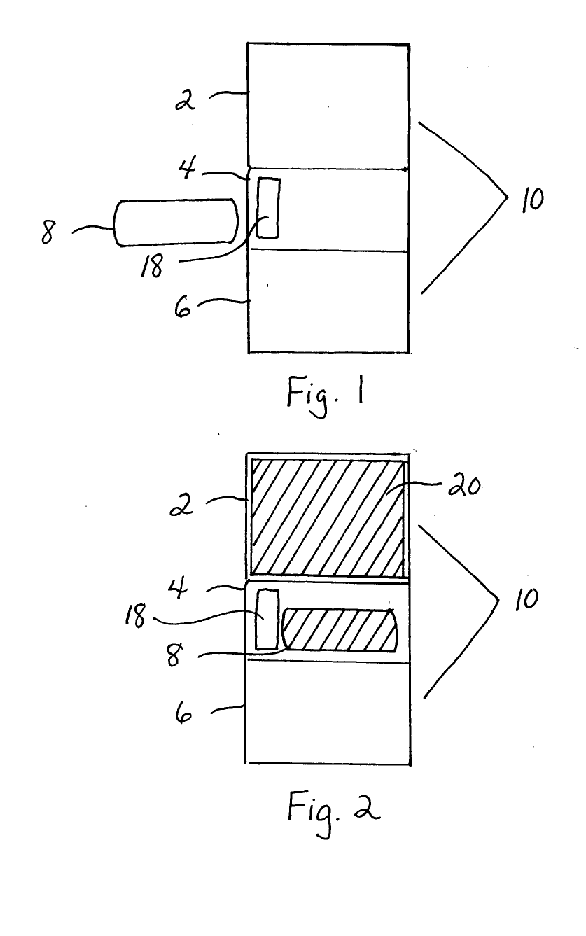

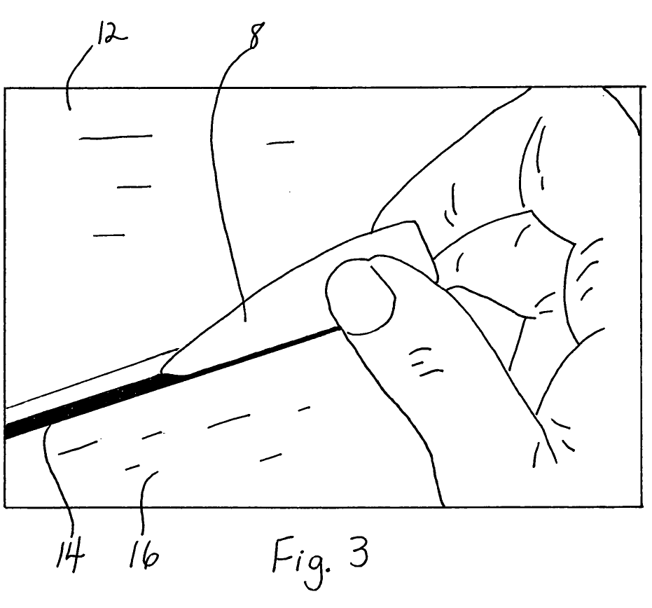

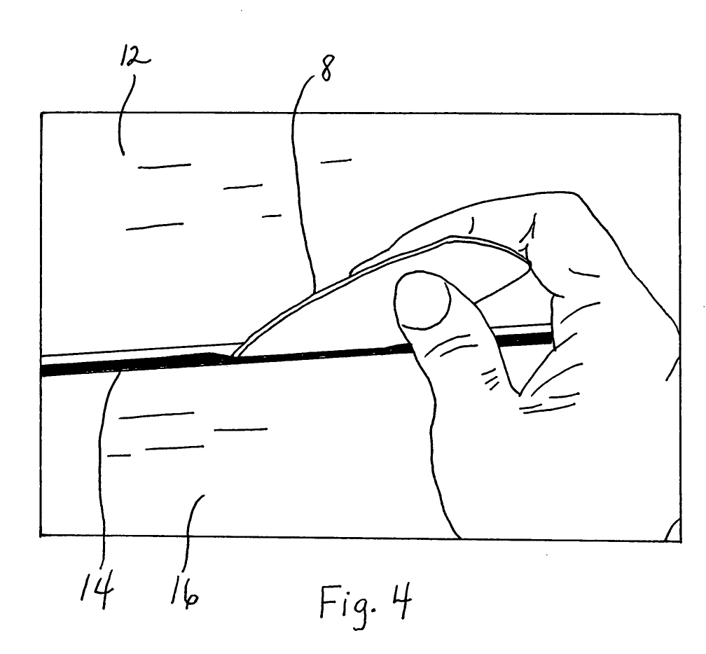

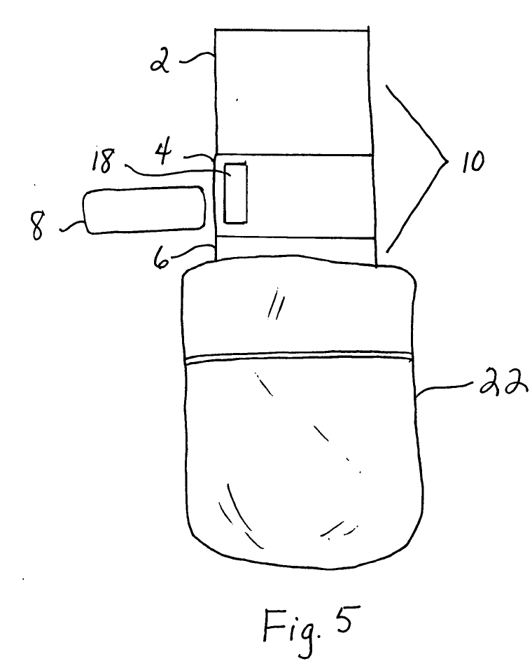

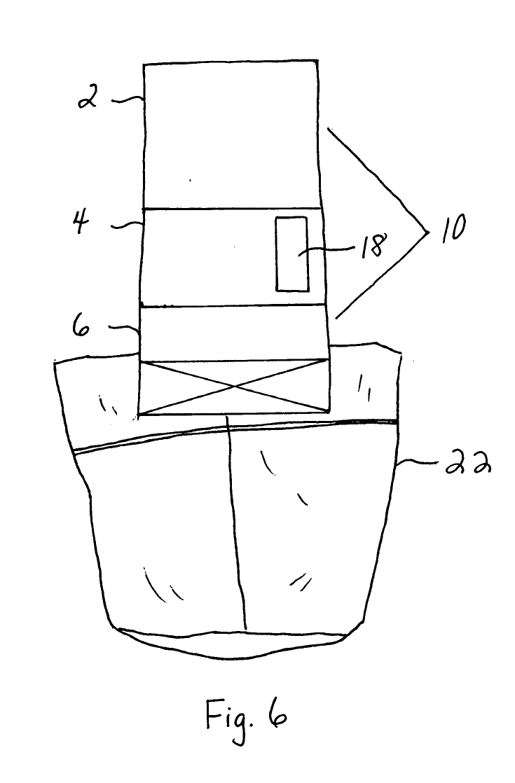

Referring now to FIGS. 1 through 13, it is hereby noted that the automobile window insert and accompanying window tool, together with the attached automobile accessories, shall be herein collectively considered to be the present invention. This invention may be, generally, described as follows:

(a) FIGS. 1, 2, 5, 6, 7, 8, 9, 10, 11, 12 and 13 illustrate the automobile window insert 2, 4, 6 (collectively 10) for hanging automobile accessories from an automobile window allowing for an incredibly secure and convenient attachment of the automobile accessories herein to an automobile window.

(b) FIGS. 1, 2, 3, 4, 5, 10 and 13 illustrate the automobile window insert's accompanying window tool 8 by which a portion of the window rubber surround located at the bottom of the window is pulled back and allowing the upper portion of the automobile window insert to be inserted between the automobile window and its rubber surround and into that portion of the automobile into which the window disappears, thus allowing the automobile accessories to hang down from the window and rest on the door of the automobile or the body of the automobile, if there is no door below the window, whichever the case my be, to allow for convenience in utilizing the various automobile accessories herein.

(c) FIGS. 5, 6, 7, 8, 9, 10, 11, 12 and 13 illustrate the many different automobile accessories set forth herein which utilize the above automobile window insert and accompanying window tool in order to attach to the automobile window, said automobile accessories providing the driver and passengers in an automobile the incredibly secure, convenient and organized use of the various items described herein.

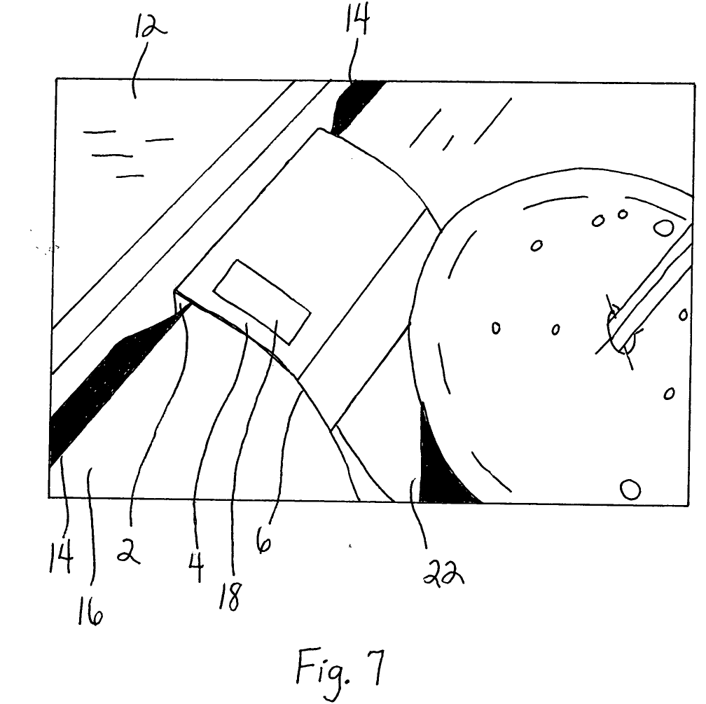

The automobile window insert 10 and accompanying window tool 8 for hanging automobile accessories from an automobile window, along with the automobile accessories referred to herein, are useable by the driver and passengers of an automobile, as illustrated in FIGS. 7, 10 and 13, by means of sliding the upper portion of the automobile window insert 2 between the automobile window 12 and its rubber surround 14 by means of the accompanying window tool 8, thus allowing the automobile accessories to hang down from the window 12 and rest on the door of the automobile 16 or the body of the automobile, if there is no door below the window, whichever the case may be.

The automobile window insert 2, 4, 6 (collectively 10) as illustrated in FIGS. 1, 2, 5, 6, 7, 8, 9, 10, 11, 12 and 13, and the automobile accessories as illustrated in FIGS. 5, 6, 7, 8, 9, 10, 11, 12 and 13, are made from fabric, hard plastic (optional), vinyl (optional) and hook and loop fasteners (optional) 18 using conventional sewing methods; and the accompanying window tool 8 as illustrated in FIGS. 1, 2, 3, 4, 5, 10 and 13 is made from hard plastic; notwithstanding the above materials, it is specifically stated that the aforementioned automobile window insert 2, 4, 6 (collectively 10), window tool 8 and automobile accessories may be made or formed from any number of materials, including, but not limited to, one solid piece or multiple pieces of plastic, metal, fabric, or any and all materials whatsoever, and that the use of different materials to make the aforementioned, and whether or not a window tool 8 is necessary or required, shall be considered as coming within the spirit of the invention and are desired to be protected.

The automobile window insert 2, 4, 6 (collectively 10) consists, generally, of the following:

(a) As illustrated in FIGS. 1, 2, 5, 6, 7, 8, 9, 10, 11, 12 and 13, a piece of fabric of varying sizes, depending upon the automobile accessory to be attached, said fabric being cut on a fold and being divided into sections as follows:

1. As illustrated in FIGS. 1, 2, 5, 6, 8, 9, 11 and 12, the upper section 2 beginning along the fold in the fabric having a seam stitched up both the right and left sides to form a type of pocket into which a corresponding piece of hard plastic 20, as that hatched portion illustrated in FIG. 2, is inserted along the fold from one side to the other and extending down a distance of approximately 3″ and having a stitch below said corresponding piece of hard plastic 20 from one side to the other to fully enclose said hard plastic 20. This upper portion of the automobile window insert 2 containing the corresponding hard plastic 20 is used by sliding it between the automobile window 12 and its rubber surround 14 as illustrated in FIGS. 7, 10 and 13 and inserting the entire portion of the automobile window insert 2 containing the corresponding hard plastic 20 into that portion of the automobile door 16 into which the window disappears by means of the below described window tool 8 provided, thus allowing the automobile accessory to hang down from the window and rest on the door 16 of the automobile, or the body of the automobile if there is no door below the window, whichever the case may be.

2. As illustrated in FIGS. 1, 2, 5, 6, 7, 8, 9, 10, 11, 12 and 13, the middle section 4 being that portion of the above fabric extending downward for a distance of approximately ½″ from the seam stitched below the hard plastic and serving the purpose of filling the gap between the portion of the automobile window insert 2 that has been inserted into the automobile door 16 and that portion of the automobile window insert 6 which attaches to the automobile accessory. This middle section 4 allows the automobile accessory to hang over that portion of the door 16 or body of the automobile if there is no door below the window, whichever the case may be, which abuts the rubber window surround 14 and allows the automobile accessory to hang properly.

3. As illustrated in FIGS. 1, 2, 5, 6, 7, 8, 9, 10, 11, 12, in most instances, this middle section 4 also contains a pocket for the storage of the below described window tool 8 being formed by stitching down one side of the fabric while leaving the other side open, said open side being held closed by hook and loop fasteners 18. In other instances, the window tool 8 may be stored in a storage slot located elsewhere on the automobile accessory.

4. As illustrated in FIGS. 1, 2, 5, 6, 7, 8 9, 10, 11 and 12, a lower section 6 (optional) being that portion of the above fabric extending downward from the middle section 4 and being the location where the automobile window insert 2, 4, 6 (collectively 10) is stitched to the automobile accessory.

(b) A window tool 8 as illustrated in FIGS. 1, 2, 3, 4, 5, 10 and 13, being made from hard plastic of varying sizes ranging from approximately 4½″ long×1⅛″ high to approximately 2¾″ long×1″ high, depending upon the automobile accessory it accompanies, and having rounded and thinned out corners to allow for ease in pulling back a small portion of the automobile window's 12 rubber surround 14 allowing the above described upper portion of the automobile window insert 2 to slide into place into that portion of the automobile into which the window 12 disappears, thus allowing the automobile accessory to hang down from the window 12 and rest on the door 16 of the automobile, or the body of the automobile if there is no door below the window, whichever the case may be.

As illustrated in FIGS. 5, 6, 7, 8, 9, 10, 11, 12 and 13, the automobile accessories consist, generally, of fabric, vinyl (optional) of varying shapes and sizes, depending upon the automobile accessory being referred to, said fabric and vinyl (optional) being stitched to form a type of pocket to be used as all manner of cupholders 22, cellphone holders 24, iPod/MP3/satellite radio holders 24, CD holders 26, sunglasses holders 26, garbage holders 22, tissue holders 28, accessory/food trays/holders 30, and any and all types of holders, trays, containers, vessels, receptacles, or any and all items whatsoever, some of which are more particularly described hereinbelow, and the omission of a further particular description or drawing of any of the other said automobile accessories referred to herein shall not preclude their protection by virtue of this Nonprovisional Patent Application:

As illustrated in FIGS. 5, 6 and 7, the cupholder/garbage holder 22 (which may be used to hold cups, garbage or any number of items desired by the user) being made from a piece of fabric measuring approximately 15″ long×5″ high (the “lower portion”), being stitched to a piece of fabric creating a band around the top and being cut on a fold and measuring 15″ long×2″ high (the “upper portion”), with said lower portion then being stitched to pieces of fabric and vinyl being cut in circles measuring 5¾″ in diameter to form the bottom of the cupholder/garbage holder 22, with the automobile window insert 10 described herein being stitched to the upper portion to allow it to hang down from the window 12 and rest on the door 16 of the automobile, or the body of the automobile if there is no door below the window, whichever the case may be. Said holder may be made in various shapes and sizes in order to accommodate any number of items desired by the user.

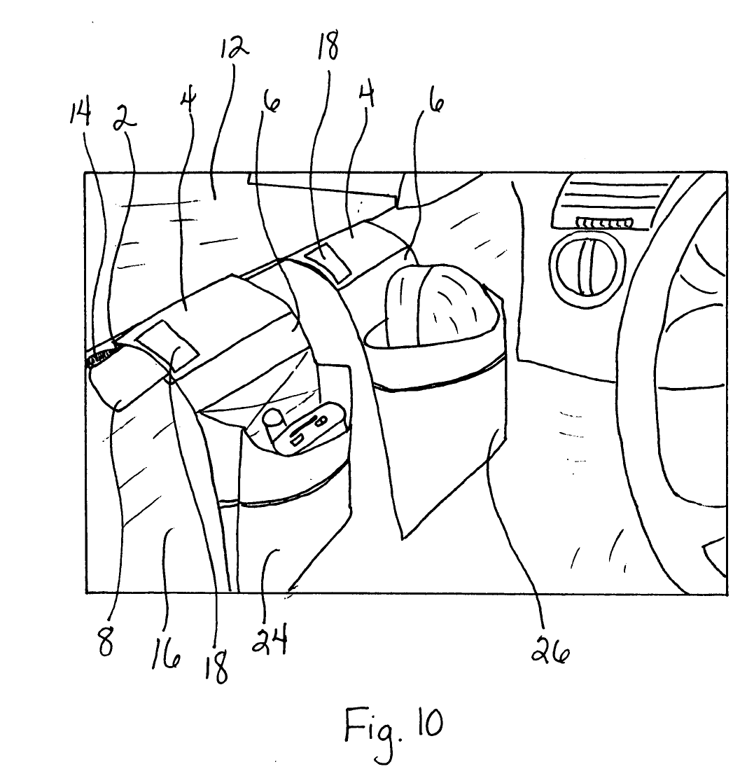

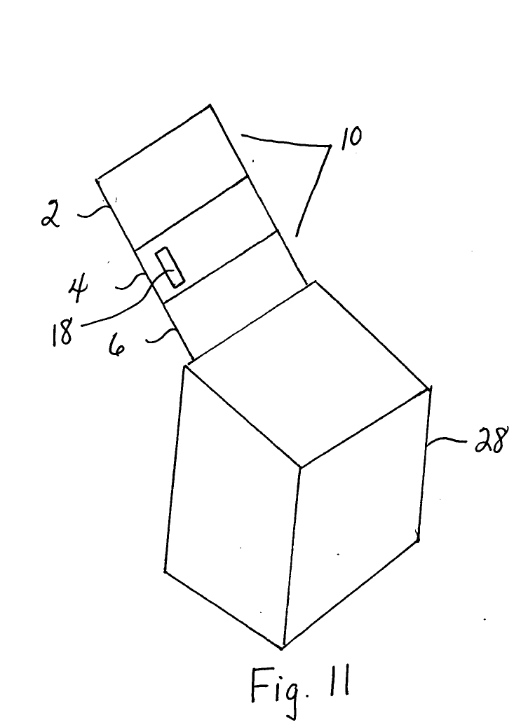

As illustrated in FIGS. 9 and 10, the cellphone/iPod/MP3/satellite radio holder 24 (which may be used to hold any number of items desired by the user) being made from a piece of fabric measuring 12″ long×5″ high (which includes a band around the top), said fabric being folded in half horizontally and being stitched across the bottom and then down both sides in such a way as to form an accordion type opening on either side of the band around the top, with the automobile window insert 10 being attached to the band along the top to allow it to hang down from the window 12 and rest on the door 16 of the automobile, or the body of the automobile if there is no door below the window, whichever the case may be. Said holder may be made in various shapes and sizes in order to accommodate any number of items desired by the user.

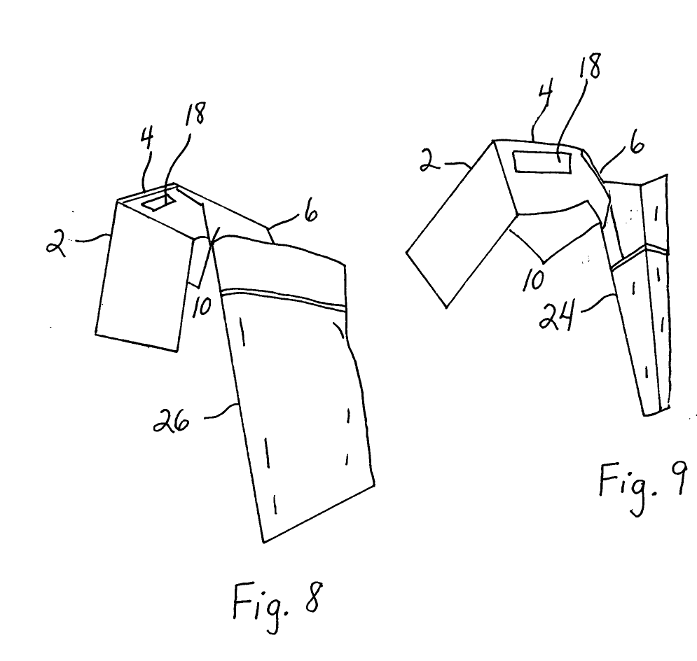

As illustrated in FIGS. 8 and 10, the CD/sunglasses holder 26 (which may be used to hold CD's, sunglasses in or out of a case, accessories chargers, maps, notepads, pens or any number of items desired by the user) being made from a piece of fabric measuring 13″ long×6″ high (which includes a band around the top), said fabric being folded in half horizontally and being stitched down one side and across the bottom, with the automobile window insert 10 being attached along the top to allow it to hang down from the window 12 and rest on the door 16 of the automobile, or the body of the automobile if there is no door below the window, whichever the case may be. Said holder may be made in various shapes and sizes in order to accommodate any number of items desired by the user.

As illustrated in FIG. 11, the tissue holder 28 (which may be used to hold tissues or any number of items desired by the user) being made from a piece of fabric measuring 21″ long×6″ high, said fabric being folded in such a way as to stitch four sides in the shape of a tissue box, and being attached to a bottom section of approximately 4½ ″ square, with the automobile window insert 10 being attached along the top to allow it to hang down from the window 12 and rest on the door 16 of the automobile, or the body of the automobile if there is no door below the window, whichever the case may be. Said holder may be made in various shapes and sizes in order to accommodate any number of items desired by the user.

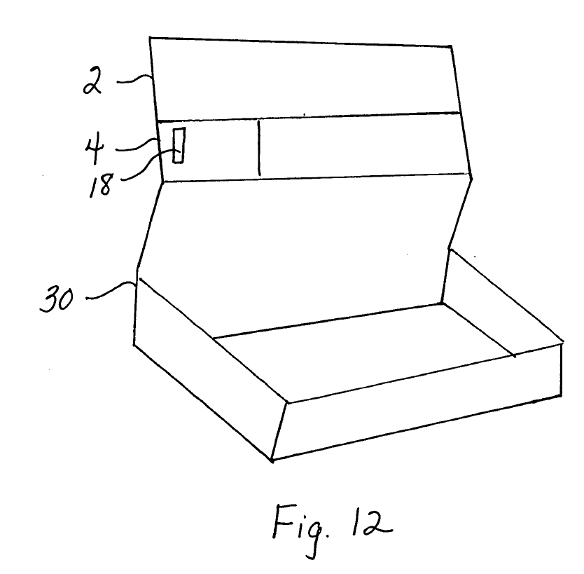

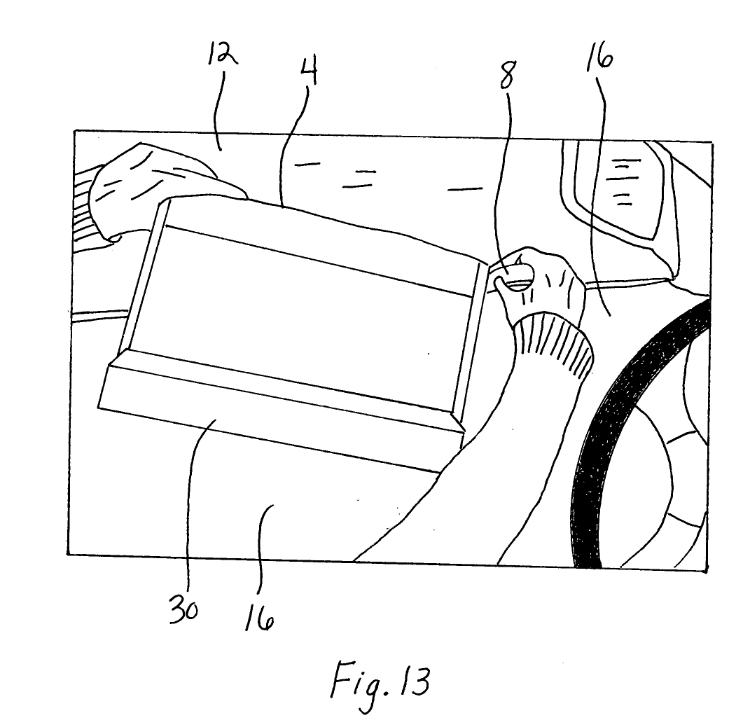

As illustrated in FIGS. 12 and 13, the accessory/food trays/holder 30 (which may be used to hold accessories/food or any number of other items desired by the user, being made from fabric, vinyl (optional) and hard plastic and consists, generally, of the following:

(a) A bottom flat surface being approximately 11½″ wide×6″ deep (the “tray bottom”) made from fabric surrounding a corresponding hard plastic;

(b) Said tray bottom being surrounded in the front and on both the left and right sides by a lip rising 1½″ from said tray bottom at a 90 degree angle (the “tray lip”) and being made from fabric surrounding, in the front, a corresponding hard plastic, thus providing, together with the below referenced tray back, a continuous barrier that prevents items from sliding off the tray bottom;

(c) A back section rising at a 90 degree angle from the rear of the tray bottom being approximately 11½″ wide×6″ high (the “tray back”);

(d) An automobile window insert section 10 continuing upward from the back section at a 90 degree angle from the rear of the tray bottom and being approximately 11½″ wide×4¾″ high and being attached along the top to allow it to hang down from the window 12 and rest on the door 16 of the automobile, or the body of the automobile if there is no door below the window, whichever the case may be. Said holder may be made in various shapes and sizes in order to accommodate any number of items desired by the user.

Any and all types of holders, trays, containers, vessels, receptacles, or any and all items whatsoever, which utilize the automobile window insert 10 and/or accompanying window tool 8 herein.

The automobile window insert 10 and accompanying window tool 8, together with the automobile accessories herein, may be stored neatly and compactly in an automobile glove compartment, under the automobile seats, in the storage compartments located in the automobile doors or located on the back of the front driver's and passenger's seats, etc.

While the invention has been illustrated and described in detail in the drawings and foregoing description, the same is to be considered as illustrative and not restrictive in character. It should be understood that all changes and modifications that come within the spirit of the invention are desired to be protected.

The automobile window insert and accompanying window tool herein, together with the attached automobile accessories herein, being collectively known as the invention, having been described herein with reference to the illustrated and presently preferred embodiments. Other modifications and variations of the invention will be readily apparent to those of skill in the art. The foregoing drawings, discussion and descriptions are illustrative of specific embodiments but are not meant to be unduly limited by this disclosure of the presently preferred embodiments. It is to be understood that the following claims are intended to cover all of the generic and specific features of the invention herein described, and all statements of the scope of the invention which, as a matter of language, might be said to fall therebetween. It is intended that the invention be defined, by the means, and their obvious equivalents, set forth in the following claims:

1. A means for hanging from an automobile window any and all automobile accessories whatsoever to be utilized by either the driver or passenger of an automobile.

2. The means of claim 1 comprising an automobile window insert.

3. The means of claim 1 also comprising a window tool.

4. The automobile window insert of claim 2 being utilized by sliding a portion of the automobile window insert between the automobile window and its rubber surround and into that portion of the automobile into which the window disappears, thus allowing the automobile accessories to hang down from the window.

5. The window tool of claim 3 being made of hard plastic and having rounded and thinned out corners to allow for ease in pulling back a small portion of the automobile window's rubber surround allowing the automobile window insert to be inserted into that portion of the automobile into which the window disappears, thus allowing the automobile accessories to hang down from the window.

6. The automobile window insert of claim 2 being comprised of an upper section being made of fabric surrounding a corresponding hard plastic, a middle section being made of fabric and sometimes including a pocket for storage of the window tool, and a lower section (optional) being made of fabric and being that portion of the automobile window insert that is attached to the various automobile accessories.

7. The automobile window insert of claim 6 being attached to a cupholder/garbage holder.

8. The cupholder/garbage holder of claim 7 being made of fabric and vinyl and consisting of a bottom section cut in circles of varying diameters depending upon the size of holder desired and being where the bottom of the cup or garbage will rest; said bottom section being attached to a top section, including a band around the top (optional), of varying sizes depending upon the size of the holder creating a type of circular pocket and being where the body of the cup or the garbage will be held; and the automobile window insert being attached to the top of the holder thus allowing it to hang from the automobile window.

9. The automobile window insert of claim 6 being attached to a cellphone/iPod/MP3/satellite radio holder.

10. The cellphone/iPod/MP3/satellite radio holder of claim 9 (which may be used to hold any number of items by the user) being made from fabric of varying shapes and sizes depending upon the size of the holder desired, including a band around the top (optional), said fabric being folded in half horizontally and being stitched across the bottom and down both sides in such a way as to form an accordion type opening on either side of the top, thus creating a type of flat, expandable pocket; and the automobile window insert being attached to the top of the holder thus allowing it to hang from the automobile window.

11. The automobile window insert of claim 6 being attached to a CD/sunglasses holder.

12. The CD/sunglasses holder of claim 11 (which may be used to hold any number of items by the user) being made from fabric of varying shapes and sizes depending upon the size of the holder desired, including a band around the top (optional), said fabric being folded in half horizontally and being stitched down one side and across the bottom in such a way as to create a type of flat pocket; and the automobile window insert being attached to the top of the holder thus allowing it to hang from the automobile window.

13. The automobile window insert of claim 6 being attached to a tissue holder.

14. The tissue holder of claim 13 (which may be used to hold tissues or any number of items desired by the user) being made of fabric and consisting of a bottom section cut in a square of varying sizes depending upon the size of holder desired and being the bottom of the holder where the bottom of the box of tissues will rest; said bottom section being attached to a top section, including a band around the top (optional), of varying sizes depending upon the size of the holder, stitched in such a way to create four sides thus making a type of square pocket and being where the body of the tissue box will be held; and the automobile window insert being attached to the top section of the tissue holder thus allowing it to hang from the automobile window.

15. The automobile window insert of claim 6 being attached to an accessory/food tray/holder.

16. The accessory/food tray/holder of claim 15 (which may be used to hold any number of items desired by the user) being made of fabric and vinyl (optional), and hard plastic and consisting of the tray bottom; a tray lip, which together with the below referenced tray back, provides a continuous barrier that prevents items from sliding off the tray bottom; a tray back; and the automobile window insert being attached to the tray back thus allowing it to hang from the automobile window.
